(19) United States
(12) Patent Application Publication
(10) Pub. No.: US 2015/0310346 A1
(43) Pub. Date: Oct. 29, 2015

(54) OPTIMIZATION DEVICE, OPTIMIZATION METHOD AND OPTIMIZATION PROGRAM

(71) Applicant: NEC CORPORATION, Minato-ku, Tokyo (JP)

(72) Inventor: Takashi SHIRAKI, Tokyo (JP)

(73) Assignee: NEC Corporation, Minato-ku, Tokyo (JP)

(21) Appl. No.: 14/650,022

(22) PCT Filed: Nov. 19, 2013
(86) PCT No.: PCT/JP2013/006777

§ 371 Date: Jun. 5, 2015

(30) Foreign Application Priority Data
Dec. 5, 2012 (JP) 2012-266597

(51) Int. Cl. G06N 7/00; G06N 99/00

(52) U.S. Cl. CPC G06N 7/00; G06N 99/005

(57) ABSTRACT

An optimization device includes: a selection unit 101 which selects a node to be played out in a solution search in an optimization calculation from among nodes as options in a search tree; a first calculation unit 102 which executes a playout from the selected node to search for a solution; and a second calculation unit 103 which sets the solution after the playout as an initial solution to search for a solution by a heuristic method, a local search method, or a neighborhood search method.

### TECHNICAL FIELD

The present invention relates to an optimization device, an optimization method, and an optimization program applied to a solution search in an optimization calculation.

### BACKGROUND ART

An optimization problem is often a problem based on a set objective function and constraints to derive one optimal solution that makes the objective function best under the constraints. Optimization used in an OR (Operations Research) or the like usually enumerates the best one solution to one objective function and elements from which the solution is derived. However, since checking for all possible solutions to find one optimal solution leads to enormous combinations of solutions, this is often impossible in practice. Therefore, a solution search method is important in the optimization calculation. As solution search methods, there are a branch-and-bound method and a heuristic method. As heuristic methods, there are an evolutionary method, such as a simulated annealing method (hereinafter referred to as SA) or a genetic algorithm (hereinafter referred to as GA), a tabu search, and the like.

On the other hand, though not for optimization, there is index UCB (Upper Confidence Bound) as a method of solving an MBP (Multi-Armed Bandit Problem) for evaluating multiple options to make a decision (see Non Patent Literature (NPL) 1). The UCB is to add a simulation by a simple method, such as a random simulation, after an option is selected, and evaluate the result in order to derive a final decision.

Further, a Monte Carlo Tree Search (MCTS) can be applied to optimization for enumerating all stages to find one solution, rather than selecting an option in one stage, by using the UCB in multiple stages. As described in NPL 2, since a solving method using MCTS requires no domain knowledge, it is easily applied to a variety of domains (fields, areas). Therefore, if the application of MCTS to optimization can be realized, it will be highly effective.

For example, in the optimization, there is a need for a system designer to hold many hearings to know the features of the domain in order to design a better optimization system. As a result, the designer of the optimization system as an engineer having valuable skills in the design of the optimization system ends up spending an enormous amount of time. If the solving method using MCTS that requires no domain knowledge can be realized, the time required for hearings and the like can be reduced, and hence the time required for designing the optimization system can be reduced.

### CITATION LIST

### Non Patent Literatures

NPL 1: P. Auer, N. Cesa-Bianchi, and P. Fischer, “Finite-time Analysis of the Multiarmed Bandit Problem,” Machine Learning, Vol. 47, p. 235-256, 2002.

NPL 2: C. Browne, E. Powley, D. Whitehouse, S. Lucas, P. I. Cowling, P. Rohlfshagen, S. Tavener, D. Perez, S. Samothrakis, and S. Colton, “A Survey of Monte Carlo Tree Search Methods,” IEEE Transactions on Computational Intelligence and AI in Games, Vol. 4, No. 1, March 2012.

### SUMMARY OF INVENTION

### Technical Problem

However, it is difficult to succeed in the optimization by the solving method using MCTS. This is because, when an optimization problem is solved using MCTS, the accuracy of a solution is deteriorated as the problem scale increases.

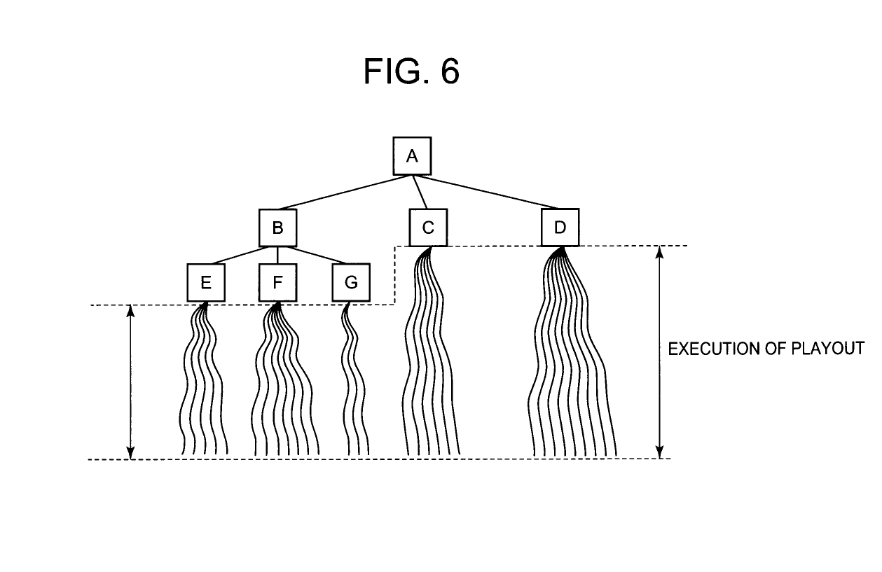

FIG. 6 is an explanatory diagram depicting a state of solution searches in an optimization calculation using MCTS. In a search tree depicted in FIG. 6, there are options from endpoint A to endpoint B, endpoint C, and endpoint D, and further, there are options from endpoint B to endpoint E, endpoint F, and endpoint G. In the solving method using MCTS, an option is selected at each endpoint, and a path to the lowermost side is eventually set as one solution to find the optimum path (solution). In this case, many playouts are tried from each of expanded endpoint E, endpoint F, endpoint G, endpoint C, and endpoint D in the halfway stage, i.e., by a simple method like random simulations. In the UCB, an average value of the trial results becomes a point of each endpoint, and a node having a higher point is expanded further below. Then, when a path to the lowermost side is found, the optimization calculation is completed. The wave lines extending from endpoint E, endpoint F, endpoint G, endpoint C, and endpoint D depicted in FIG. 6 are to depict playout search paths schematically. Further, the number of wave lines extending from each endpoint corresponds to the number of playouts. Note that the playouts are often executed in the unit of several million times or more in practice.

When the problem scale increases, some playout parts only tracking in a simple way become very long, resulting in a reduction in the solving accuracy of the playout part of each of endpoint E, endpoint F, endpoint G, endpoint C, and endpoint D. This disables the evaluation of differences in the original performance of each of endpoint E, endpoint F, endpoint G, endpoint C, and endpoint D. As a result, many playout trials are repeated in the unit of several million times or more in MCTS. However, when the depth of the tree structure in the playout parts is too deep, the solving accuracy cannot be improved by the deterioration of the accuracy due to the simply tracking way even if many playouts are tried.

Therefore, it is an object of the present invention to provide an optimization device, an optimization method, and an optimization program, capable of improving the solving accuracy when MCTS is applied to an optimization problem even if the problem scale is large.

### Solution to Problem

An optimization device according to the present invention includes: a selection unit which selects a node to be played out in a solution search in an optimization calculation from among nodes as options in a search tree; a first calculation unit which executes a playout from the selected node to search for a solution; and a second calculation unit which sets the solution after the playout as an initial solution to search for a solution by a heuristic method, a local search method, or a neighborhood search method.

An optimization method according to the present invention includes: selecting a node to be played out in a solution search in an optimization calculation from among nodes as options in a search tree; executing a playout from the selected node to search for a solution; and setting the solution after the playout as an initial solution to search for a second solution by a heuristic method, a local search method, or a neighborhood search method.

An optimization program according to the present invention causes a computer to execute: a process of selecting a node to be played out in a solution search in an optimization calculation from among nodes as options in a search tree; a process of executing a playout from the selected node to search for a solution; and a process of setting the solution after the playout as an initial solution to search for a second solution by a heuristic method, a local search method, or a neighborhood search method.

### Advantageous Effect of Invention

According to the present invention, the solving accuracy can be improved when MCTS is applied to an optimization problem even if the problem scale is large.

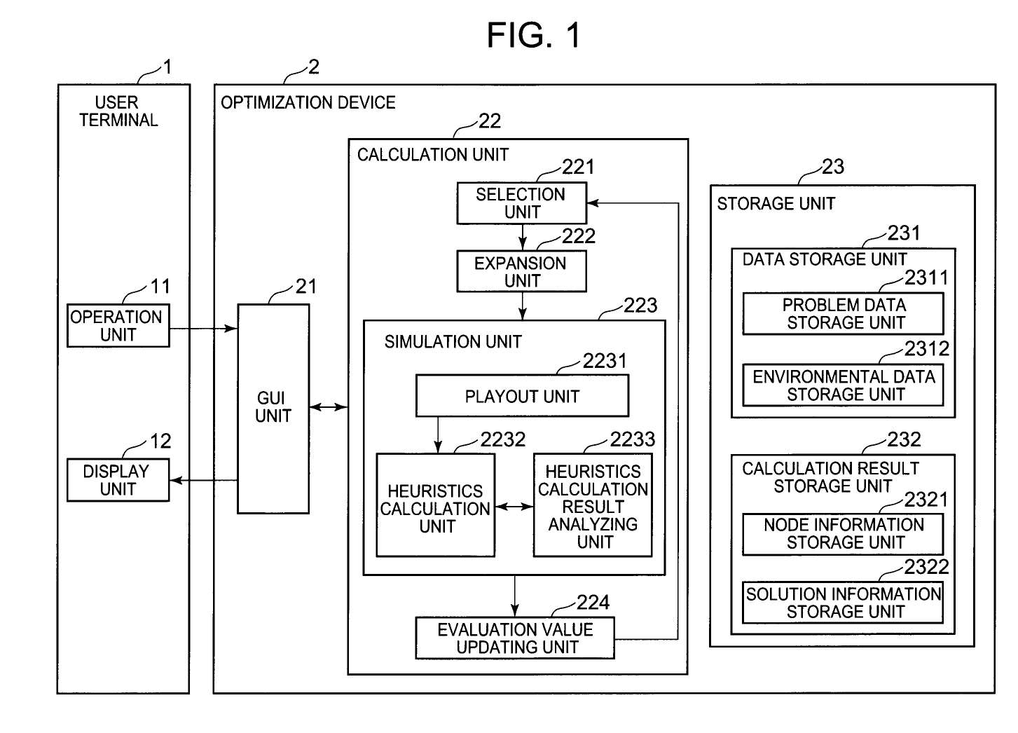

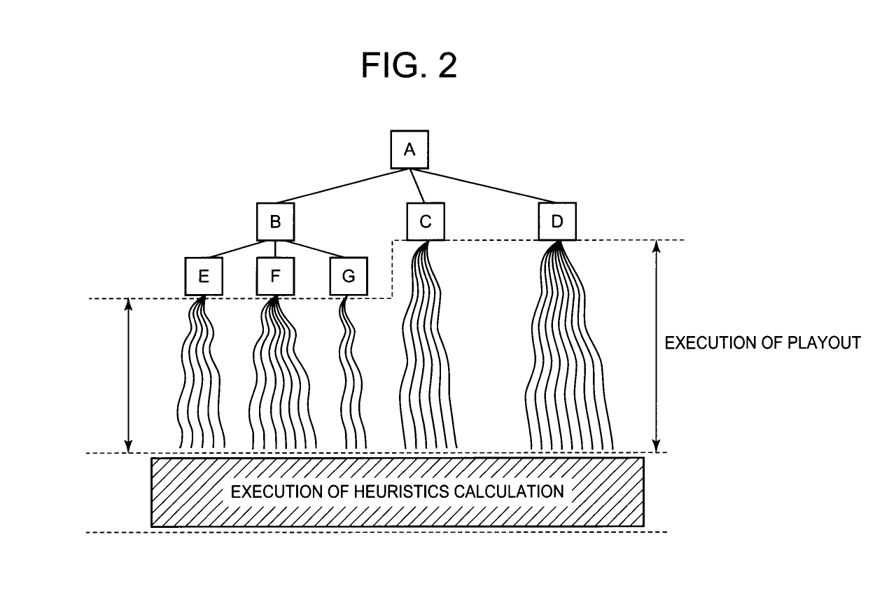

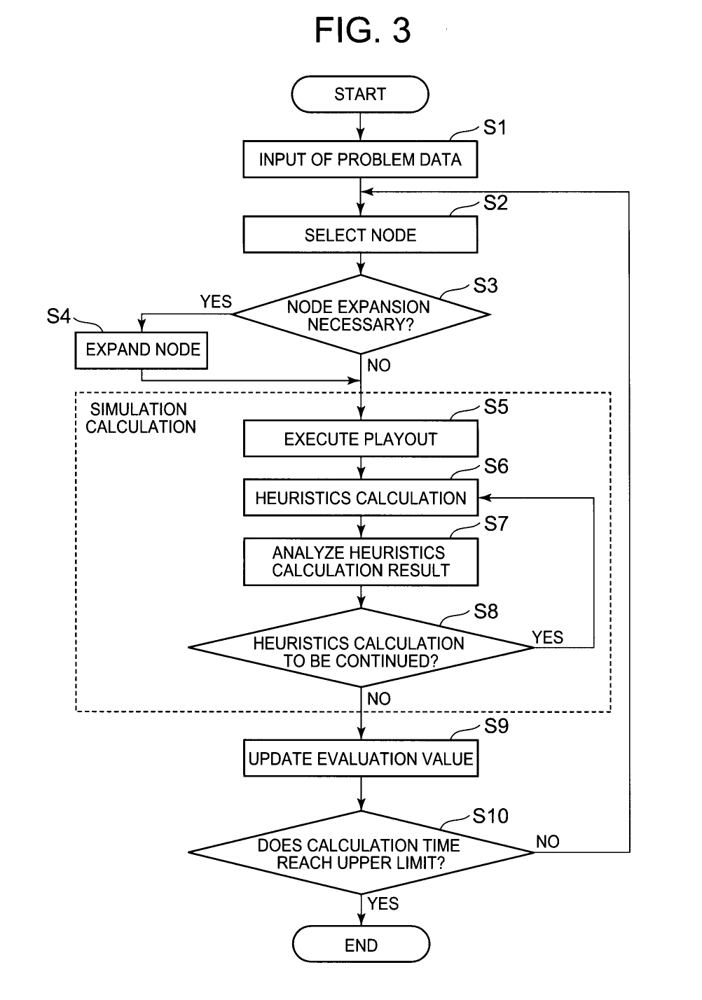

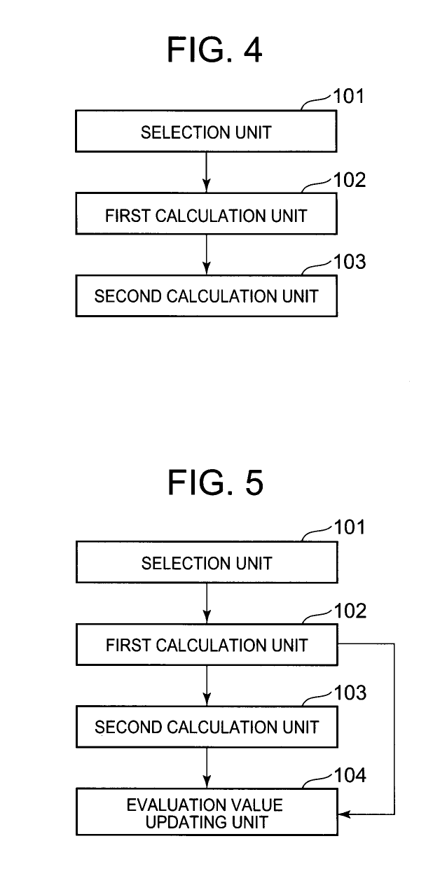

### BRIEF DESCRIPTION OF DRAWINGS

[FIG. 1] It depicts a block diagram depicting the configuration of a first exemplary embodiment of an optimization system.

[FIG. 2] It depicts an explanatory diagram depicting a state of solution searches in the first exemplary embodiment.

[FIG. 3] It depicts a flowchart depicting the operation of a calculation unit in the first exemplary embodiment.

[FIG. 4] It depicts a block diagram depicting a minimum configuration of an optimization device according to the present invention.

[FIG. 5] It depicts a block diagram depicting another minimum configuration of the optimization device according to the present invention.

[FIG. 6] It depicts an explanatory diagram depicting a state of solution searches in an optimization calculation using MCTS.

### DESCRIPTION OF EMBODIMENTS

### Exemplary Embodiment 1

A first exemplary embodiment of the present invention will be described below with reference to the accompanying drawings.

FIG. 1 is a block diagram depicting the configuration of a first exemplary embodiment of an optimization system.

As depicted in FIG. 1, the optimization system in the first exemplary embodiment includes a user terminal 1 and an optimization device 2. The user terminal 1 and the optimization device 2 are connected to be communicable with each other. Although one user terminal is illustrated in FIG. 1, any number of user terminals can be connected to the optimization device 2.

The user terminal 1 is an information processing terminal such as a personal computer. The user terminal 1 includes an operation unit 11 and a display unit 12.

The operation unit 11 inputs information necessary for an optimization calculation to be performed (hereinafter called optimization calculation input information). Further, the operation unit 11 inputs an execution instruction. The operation unit 11 outputs, to the optimization device 2, the execution instruction together with the optimization calculation input information.

The display unit 12 receives a solution as a result of the optimization calculation from the optimization device 2, and displays the solution.

The optimization device 2 includes a GUI (Graphical User Interface) unit 21, a calculation unit 22, and a storage unit 23.

The GUI unit 21 receives the optimization calculation input information from the operation unit 11 of the user terminal 1. The GUI unit 21 transmits the optimization calculation input information to the calculation unit 22. The GUI unit 21 receives, from the calculation unit 22, a set of solutions as a result of the optimization calculation, and transmits the set of solutions to the display unit 12 of the user terminal 1.

The calculation unit 22 includes a selection unit 221, an expansion unit 222, a simulation unit 223, and an evaluation value updating unit 224.

The selection unit 221 selects a node to be played out from among expanded nodes. Hereinafter, the node to be played out will be called the selected node.

The expansion unit 222 expands a search tree. Specifically, the expansion unit 222 determines whether there is a need to expand the node selected by the selection unit 221 according to a predetermined criterion, and if necessary, expands the node further to one level below the node.

The simulation unit 223 executes a simulation. The simulation unit 223 includes a playout unit 2231, a heuristics calculation unit 2232, and a heuristics calculation result analyzing unit 2233.

The playout unit 2231 searches for one solution by a playout, i.e., a simple method such as a random simulation to calculate an evaluation value of the solution.

The heuristics calculation unit 2232 sets, as an initial solution, the solution obtained by the playout to search for a solution by a heuristic method. Note that the heuristics calculation unit 2232 may search for a solution using a local search method or neighborhood search method other than the heuristic method.

The heuristics calculation result analyzing unit 2233 grasps the progress of improved solutions in the process of the heuristics calculation to determine the upper limit (time limit) of the calculation time of the heuristics calculation. Further, the heuristics calculation result analyzing unit 2233 calculates an index for updating the evaluation of the solution in the evaluation value updating unit 224. As a condition for terminating the heuristics calculation, the heuristics calculation result analyzing unit 2233 may also use any other termination condition such as the upper limit of the number of calculations. In the exemplary embodiment, a case of using the upper limit of the calculation time will be taken as an example.

The evaluation value updating unit 224 obtains the evaluation values of solutions from the playout unit 2231 and the heuristics calculation result analyzing unit 2233 to calculate and update the evaluation value of each node. Specifically, the evaluation value updating unit 224 updates the evaluation value of each node stored in a node information storage unit 2321. The evaluation value of each node contains statistics of evaluation values gathered by simulations repeatedly executed, and the evaluation value updating unit 224 updates the statistics.

The evaluation value updating unit 224 may obtain the evaluation value of a solution only from the heuristics calculation result analyzing unit 2233. In other words, the evaluation value updating unit 224 may calculate the evaluation value of each node by using both the evaluation value of a solution obtained from the playout unit 2231 and the evaluation value of a solution obtained from the heuristics calculation result analyzing unit 2233, or calculate the evaluation value of each node by using only the evaluation value of the solution obtained from the heuristics calculation result analyzing unit 2233.

The storage unit 23 includes a data storage unit 231 and a calculation result storage unit 232.

The data storage unit 231 includes a problem data storage unit 2311 and an environmental data storage unit 2312.

The problem data storage unit 2311 stores an objective function and constraints. When the optimization system is applied to a scheduling problem, the problem data storage unit 2311 stores data necessary to solve the problem (hereinafter called problem data) such as task information and person-in-charge information.

The environmental data storage unit 2312 stores environmental information, such as sensor information, changing from moment to moment and affecting the optimization calculation.

The calculation result storage unit 232 includes a node information storage unit 2321 and a solution information storage unit 2322.

The node information storage unit 2321 stores changing information such as evaluation values of nodes when calculation processing in the calculation unit 22 progresses. In the exemplary embodiment, the node information storage unit 2321 stores the number of node searches and evaluation values obtained by the calculation unit 22 in the process of each calculation.

The solution information storage unit 2322 stores solutions necessary to be held among solutions found in the calculation unit 22.

Note that the GUI unit 21 and the calculation unit 22 are implemented, for example, by a computer operating according to an optimization program. In this case, a CPU included in the optimization device 2 only has to read the optimization program and operate as the GUI unit 21 and the calculation unit 22 according to the program. Each of the GUI unit 21 and the calculation unit 22 may also be realized by separate hardware.

The problem data storage unit 2311, the environmental data storage unit 2312, the node information storage unit 2321, and the solution information storage unit 2322 are realized by a storage device such as a memory provided in the optimization device 2.

Next, the operation of the exemplary embodiment will be described.

FIG. 2 is an explanatory diagram depicting a state of solution searches in the first exemplary embodiment.

FIG. 3 is a flowchart depicting the operation of the calculation unit 22 in the first exemplary embodiment.

Here, a case where the optimization system depicted in FIG. 1 is applied to a scheduling problem is taken as an example.

First, a user enters optimization calculation input information into the operation unit 11 of the user terminal 1. The user enters, as the optimization calculation input information, problem data such as tasks for which optimization calculations are to be made, persons in charge who can work on the tasks, and the cost and effectiveness when each person in charge works on each task. At this time, the user enters an execution instruction into the operation unit 11 together with the optimization calculation input information. The operation unit 11 outputs the optimization calculation input information and the execution instruction to the optimization device 2.

When receiving the execution instruction together with the optimization calculation input information from the user terminal 1, the GUI unit 21 of the optimization device 2 transfers the optimization calculation input information to the calculation unit 22. The calculation unit 22 takes the input of the optimization calculation input information (step S1).

After step S1, the selection unit 221 in the calculation unit 22 selects a node to be simulated from among expanded nodes (step S2). Note that, since the number of nodes is only one in the initial state, the node becomes the selection target. The node selection method is based, for example, on an index such as the UCB.

When the number of playouts from the node selected by the selection unit 221 meets a predetermined condition (Yes in step S3), the expansion unit 222 expands the node to a one-level lower node (step S4). In the exemplary embodiment, the expansion unit 222 expands the node when the number of playouts exceeds a predetermined number of times. Note that, when the number of nodes is only one in the initial state, the expansion unit 222 expands the node regardless of this condition. When nodes are expanded, the expansion unit 222 sets one of the expanded nodes as the selected node.

The playout unit 2231 in the simulation unit 223 executes a playout, i.e., a random simulation from the selected node to search for one solution (step S5). Note that it is possible to execute multiple simulations on one selected node in order to search for multiple solutions. Here, as the simplest example, a method of executing one simulation on one selected node to search for one solution will be described. The technical scope of the present invention is not limited to such a form that one simulation is executed on one selected node. Therefore, such a form that multiple simulations are executed on one selected node can also be included in the technical scope of the present invention.

The heuristics calculation unit 2232 sets a solution after the playout, i.e., one solution (node) searched for in step S5 as an initial solution to the calculation made by itself to search for a better solution by a heuristic method or a local search method such as SA, continuing to calculate (step S6). In the exemplary embodiment, the heuristics calculation unit 2232 performs a heuristics calculation each time the playout unit 2231 executes a playout once. However, after the playout unit 2231 executes the playout multiple times, the heuristics calculation unit 2232 may perform a heuristics calculation on each of solutions searched by the multiple playouts, respectively. Further, the heuristics calculation unit 2232 may relatively compare respective solutions searched by the multiple playouts to perform a heuristics calculation on a solution selected based on the comparison results. According to such a form, for example, only a solution determined to be relatively better than the other solutions can be targeted for the heuristics calculation, and this can reduce the calculation time. Further, the heuristics calculation unit 2232 may determine whether to perform a heuristics calculation based on a predetermined criterion each time the playout unit 2231 executes the playout once. For example, when the accuracy of a solution searched by the playout is lower than a predetermined threshold value, the heuristics calculation unit 2232 may not perform a heuristics calculation on the solution.

The heuristics calculation result analyzing unit 2233 acquires calculation results while the heuristics calculation unit 2232 continues to calculate, i.e., the intermediate results of the heuristics calculation. The heuristics calculation result analyzing unit 2233 compares the intermediate results of the heuristics calculation with the past results of the heuristics calculation, calculates an upper limit of the calculation time of the heuristics calculation as a termination condition, and determines whether the calculation time reaches the upper limit (step S7). In the exemplary embodiment, when a difference between the intermediate results of the heuristics calculation and the past results of the heuristics calculation is smaller than or equal to a predetermined threshold value, the heuristics calculation result analyzing unit 2233 lowers the upper limit of the calculation time of the heuristics calculation. When the difference is larger than a predetermined threshold value, the heuristics calculation result analyzing unit 2233 raises the upper limit of the calculation time of the heuristics calculation. Note that the threshold values used to determine whether to lower or raise the upper limit of the calculation time may be the same value or different values. Further, the heuristics calculation result analyzing unit 2233 may change the threshold value(s) according to the elapsed time of the heuristics calculation or the progress of improved solutions in the process of the heuristics calculation.

When the calculation time of the heuristics calculation reaches the upper limit, the heuristics calculation result analyzing unit 2233 instructs the heuristics calculation unit 2232 to terminate the calculation.

Note that, in step S7, the heuristics calculation result analyzing unit 2233 may use the calculation result in the playout unit 2231 together with the calculation result of the heuristics calculation to calculate the upper limit of the calculation time of the heuristics calculation.

The heuristics calculation unit 2232 determines whether the calculation termination instruction is input, i.e., whether the heuristics calculation is to be continued or not (step S8). When the calculation termination instruction is not input, i.e., the heuristics calculation is to be continued (Yes in step S8), the heuristics calculation unit 2232 returns to step S6. When the calculation termination instruction is input (No in step S8), the heuristics calculation unit 2232 terminates the heuristics calculation.

The heuristics calculation result analyzing unit 2233 acquires a solution value at the time of terminating the calculation, and uses the solution value and the calculation result in the playout unit 2231 to calculate an evaluation value to be passed to this selected node and the upper node thereof. The calculated evaluation value becomes an index for updating the evaluation of the solution in the evaluation value updating unit 224.

The evaluation value updating unit 224 obtains, from the heuristics calculation result analyzing unit 2233, the evaluation value to be passed to the nodes to update the evaluation values of the selected node and the upper node thereof (step S9).

The calculation unit 22 repeatedly performs processing in steps S2 to S9 (selection processing, tree expansion processing, simulation calculation processing, and evaluation value updating processing) until the calculation time in the calculation unit 22 reaches the predetermined upper limit (step S10). In other words, when the calculation time does not reach the upper limit (No in step S10), the calculation unit 22 returns to step S2. When the calculation time reaches the upper limit (Yes in step S10), the calculation unit 22 ends the processing. Note that the calculation unit 22 may repeatedly perform the processing in steps S2 to S9 until the value of a solution given as a requirement, rather than the calculation time, is calculated.

In the calculation processing in steps S2 to S9, the calculation unit 22 acquires the attendance status of a person in charge, failure information on a machine necessary for task processing, and the like from the environmental data storage unit 2312.

Further, in the calculation processing in steps S2 to S9, the calculation unit 22 stores, in the node information storage unit 2321 of the calculation result storage unit 232, information including the number of node searches and the evaluation values obtained in the process of each calculation. Further, the calculation unit 22 stores, in the solution information storage unit 2322, information including solutions obtained by searches. The calculation unit 22 can acquire information stored in the node information storage unit 2321 and the solution information storage unit 2322 to recognize the number of searches for each node and the evaluation values in the process of the calculation.

Upon completion of the calculation, the calculation unit 22 passes, to the GUI unit 21, the optimization calculation result, i.e., solution information indicating a solution obtained by the searches.

The GUI unit 21 transmits the received solution information to the display unit 12 of the user terminal 1.

In the exemplary embodiment, although the case where problem data are input from the user terminal 1 to the calculation unit 22 as the optimization calculation input information is exemplified, the calculation unit 22 may acquire problem data stored in the problem data storage unit 2311. In order to realize such a form, it is only necessary for a user or the like to store the problem data in the problem data storage unit 2311 in advance.

As described above, in the exemplary embodiment, the heuristics calculation unit 2232 calculates a better solution after a playout by a heuristic method or a local search. Thus, the superiority of nodes can be determined by more accurate comparison using a heuristics calculation. This can improve the accuracy of solutions in the entire optimization calculation.

Further, in the exemplary embodiment, the heuristics calculation result analyzing unit 2233 compares the intermediate results of the heuristics calculation with the past results of the heuristics calculation to adjust the time limit for the heuristics calculation. Therefore, a wasted calculation time can be reduced to prevent the calculation time from increasing. This can restrain a reduction in the number of simulations, and hence increase the chance of finding a better solution.

In addition, in the exemplary embodiment, both the result of the playout unit 2231 and the result of the heuristics calculation result analyzing unit 2233 are used by the evaluation value updating unit 224 to update the evaluation value of each node. This enables the fair evaluation (the evaluation of the playout result) at each node and the evaluation (the evaluation of the heuristics calculation result) for obtaining a more accurate solution to be performed concurrently.

Thus, according to the exemplary embodiment, when MCTS is applied to an optimization problem, global MCTS and a local heuristic method (heuristics) particularly beneficial when the problem scale is large can be combined to improve the solving accuracy even when the problem scale is large.

In the exemplary embodiment, the case where the optimization device 2 is applied to a scheduling problem is taken as an example, but the scope of application of the present invention is not limited thereto. The present invention can be applied to general optimization problems with a focus on combinational optimization problems such as a scheduling problem for assigning a task to a person in charge.

FIG. 4 is a block diagram depicting a minimum configuration of an optimization device according to the present invention. FIG. 5 is a block diagram depicting another minimum configuration of the optimization device according to the present invention.

As depicted in FIG. 4, the optimization device according to the present invention includes: a selection unit 101 (corresponding to the selection unit 221 and the expansion unit 222 of the calculation unit 22 in the optimization device 2 depicted in FIG. 1) which selects a node to be played out in a solution search in an optimization calculation from among nodes as options in a search tree; a first calculation unit 102 (corresponding to the playout unit 2231 of the simulation unit 223 of the calculation unit 22 in the optimization device 2 depicted in FIG. 1) which executes a playout from the selected node to search for a solution; and a second calculation unit 103 (corresponding to the heuristics calculation unit 2232 and the heuristics calculation result analyzing unit 2233 of the simulation unit 223 of the calculation unit 22 in the optimization device 2 depicted in FIG. 1) which sets the solution after the playout as an initial solution to search for a solution by a heuristic method, a local search method, or a neighborhood search method.

According to this configuration, when MCTS is applied to an optimization problem, global MCTS and a local heuristic method (heuristics), a local search method, or a neighborhood search method, which is particularly beneficial when the problem scale is large, can be combined to improve the solving accuracy even if the problem scale is large. This is because an accurate comparison can be made by the heuristic method or the like to determine the superiority of nodes.

As depicted in FIG. 5, the following optimization devices are also disclosed in the aforementioned embodiment.

(1) An optimization device wherein the second calculation unit 103 calculates a termination condition of a calculation time in the second calculation unit 103 based on the solution searched for by the first calculation unit 102 and the solution searched for by the second calculation unit 103, and when the termination condition is satisfied, terminates calculation processing in the second calculation unit 103.

According to this configuration, a wasted calculation time can be reduced to prevent the calculation time from increasing. This can restrain a reduction in the number of simulations, and hence increase the chance of finding a better solution.

(2) An optimization device further including an evaluation value updating unit 104 (corresponding to the evaluation value updating unit 224 of the calculation unit 22 in the optimization device 2 depicted in FIG. 1) which updates an evaluation value of each node based both on an evaluation value of the solution searched for by the first calculation unit 102 and an evaluation value of the solution searched for by the second calculation unit 103, or only on the evaluation value of the solution searched for by the second calculation unit 103.

According to this configuration, the fair evaluation (the evaluation of the playout result) at each node and the evaluation (the evaluation of the heuristics calculation result) for obtaining a more accurate solution can be performed concurrently.

(3) An optimization device wherein the second calculation unit 103 searches for a solution by a heuristic method, a local search method, or a neighborhood search method to a solution that fulfills a predetermined criterion among solutions searched for during playouts executed by the first calculation unit 102 or to a solution selected based on a result of relative comparison of respective solutions among the solutions searched for during playouts executed multiple times by the first calculation unit 102.

According to this configuration, among solutions searched for by respective playouts, only a solution that fulfills a predetermined criterion can be targeted for a heuristics calculation. Even when the heuristics calculation is performed on a solution searched by multiple playouts after the playouts are executed multiple times, a solution selected by relative comparison with other solutions, for example, only a solution determined to be relatively better than the other solutions can be targeted for the heuristics calculation. This can more reduce a wasted calculation time.

While the present invention has been described with reference to the exemplary embodiment and examples, the present invention is not limited to the aforementioned exemplary embodiment and examples. Various changes that can be understood by those skilled in the art within the scope of the present invention can be made to the configurations and details of the present invention.

This application is based upon and claims the benefit of priority from Japanese patent application No. 2012-266597, filed on Dec. 5, 2012, the disclosure of which is incorporated herein in its entirety by reference.

### REFERENCE SIGNS LIST

1 user terminal

2 optimization device

11 operation unit

12 display unit

21 GUI unit

22 calculation unit

23 storage unit

101, 221 selection unit

102 first calculation unit

103 second calculation unit

104 evaluation value updating unit

222 expansion unit

223 simulation unit

224 evaluation value updating unit

231 data storage unit

232 calculation result storage unit

2231 playout unit

2232 heuristics calculation unit

2233 heuristics calculation result analyzing unit

2311 problem data storage unit

2312 environmental data storage unit

2321 node information storage unit

2322 solution information storage unit

What is claimed is:

1. An optimization device comprising:
a selection unit which selects a node to be played out in a solution search in an optimization calculation from among nodes as options in a search tree;
a first calculation unit which executes a playout from the selected node to search for a solution; and
a second calculation unit which sets the solution after the playout as an initial solution to search for a solution by a heuristic method, a local search method, or a neighborhood search method.

2. The optimization device according to claim 1, wherein the second calculation unit calculates a termination condition of a calculation time in the second calculation unit based on the solution searched for by the first calculation unit and the solution searched for by the second calculation unit, and when the termination condition is satisfied, terminates calculation processing in the second calculation unit.

3. The optimization device according to claim 1, further comprising an evaluation value updating unit which updates an evaluation value of each node based both on an evaluation value of the solution searched for by the first calculation unit and an evaluation value of the solution searched for Docket No. J-15-0067 by the second calculation unit, or only on the evaluation value of the solution searched for by the second calculation unit.

4. The optimization device according to claim 1, wherein the second calculation unit searches for a solution by the heuristic method, the local search method, or the neighborhood search method to a solution that fulfills a predetermined criterion among solutions searched for during playouts executed by the first calculation unit or to a solution selected based on a result of relative comparison of respective solutions among the solutions searched for during playouts executed a plurality of times by the first calculation unit.

5. An optimization method comprising:
selecting a node to be played out in a solution search in an optimization calculation from among nodes as options in a search tree;
executing a playout from the selected node to search for a solution; and
setting the solution after the playout as an initial solution to search for a second solution by a heuristic method, a local search method, or a neighborhood search method.

6. The optimization method according to claim 5, wherein a termination condition of a calculation time for searching for the second solution is calculated based on the initial solution and the second solution, and when the termination condition is satisfied, calculation processing for searching for the second solution is terminated.

7. The optimization method according to claim 5, wherein an evaluation value of each node is updated based both on an evaluation value of the initial solution and an evaluation value of the second solution, or only on the evaluation value of the second solution.

8. A non-transitory computer readable information recording medium storing an optimization program, when executed by a processor, that performs a method for
selecting a node to be played out in a solution search in an optimization calculation from among nodes as options in a search tree;
executing a playout from the selected node to search for a solution; and
setting the solution after the playout as an initial solution to search for a second solution by a heuristic method, a local search method, or a neighborhood search method.

9. The non-transitory computer readable information recording medium according to claim 8, calculating a termination condition of a calculation time for searching for the second solution based on the initial solution and the second solution, and when the termination condition is satisfied, terminating calculation processing for searching for the second solution.

10. The non-transitory computer readable information recording medium according to claim 8, updating an evaluation value of each node based both on an evaluation value of the initial solution and an evaluation value of the second solution, or only on the evaluation value of the second solution.
